(19) United States
(12) Patent Application Publication
(10) Pub. No.: US 2023/0362102 A1
(43) Pub. Date: Nov. 9, 2023

(54) A CABLE MODEM AND ITS EXECUTION METHOD AND A COMPUTER READABLE MEDIUM

(71) Applicant: ARRIS Enterprises LLC, Suwanee, GA (US)

(72) Inventors: Jianming LIANG, Shenzhen, Guangdong (CN); Jinji GUO, Shenzhen, Guangdong (CN)

(21) Appl. No.: 18/022,837

(22) PCT Filed: Aug. 17, 2021
(86) PCT No.: PCT/US2021/046232

§ 371 Date: Feb. 23, 2023

(30) Foreign Application Priority Data
Sep. 1, 2020 (CN) 202010903853.1

(51) Int. Cl. H04L 47/72; H04L 12/28; H04W 28/20

(52) U.S. Cl. CPC H04L 47/72; H04L 12/2801; H04W 28/20

(57) ABSTRACT

Some aspects of the present publication relate to a cable modem, i.e. CM, comprising a memory unit, in which instructions are saved, and a processor. The processor is configured to execute the instructions saved in said memory unit so that said electronic device executes the following operations: Receiving special service flow configuration information; said special service flow configuration information comprises information, which is configured by users and used for enabling the establishment of special service flows with one or a plurality of client stations connected with the CM; and establishing said special service flows with the cable modem terminal system, i.e. the CMTS, using the dynamic service flow technology based on said special service flow configuration information; said special service flows are only used for the communication with said one or plurality of client stations.

### TECHNICAL FIELD

The present publication overall relates to network technologies, and more specifically it relates to a cable modem and its execution method as well as a computer readable medium.

### BACKGROUND ART

In a family network, usually, a plurality of client stations are connected to a cable modem (CM). Client stations include Ethernet client stations (hereinafter referred to as LAN Stations) and Wi-Fi client stations (hereinafter referred to as Wi-Fi Stations); wherein, Wi-Fi Stations are connected to the CM via Wi-Fi Access Points (Wi-Fi AP). A Wi-Fi access point may be an independent device connected with the CM or integrated with the CM. The CM is connected with the cable modem terminal system (CMTS).

A CM is a terminal device located in the home of a user, and its function is mainly to demodulate download signals from the CMTS into digital signals to be transmitted to client stations and to modulate the upload data signals from client stations and transmit them back to the CMTS via the backhaul network, during the process of broadband connection. A CMTS is a device managing and controlling the CM, and it is responsible for exchanging the data from the CM with the IP network.

In an actual use scenario, the requirements for network resources by various client stations in a family network may be different. For example, when a user is having real-time video communication or playing online games on certain client stations, he/she usually wishes that such real-time communication is well guaranteed.

In the related art, a Wi-Fi access point (Wi-Fi AP) provides the airtime management (ATM) function. It allows a user to have guaranteed bandwidth support for the corresponding Wi-Fi Station by designating a higher priority and a certain airtime ratio (i.e. percentage) for a specific MAC address. For example, a user may allocate a percentage, for example, 10%, of the total throughput of the Wi-Fi AP to a specific MAC address and allocate a high priority so that regardless how the Wi-Fi AP competes among a plurality of Wi-Fi Stations, 10% of the throughput is always guaranteed for the Wi-Fi Station with such MAC address.

However, the user can only affect the resource allocation to a specific MAC address at the Wi-Fi AP side by configuring the ATM, but cannot affect the bandwidth allocation of the CM to various client stations connected therewith. Various client stations of the CM compete with each other.

Under a CMTS, hundreds of CMs are usually connected. The connected CMs compete with each other. Between a CM and a CMTS, the dynamic service flow technology may be used to establish the service flow for such CM (for example, upload service sub-flow and download service sub-flow). The service flow established between the CM and CMTS by the dynamic service flow technology can guarantee that when the CM competes with other CMs connected with the CMTS, the CM always has the bandwidth guaranteed by such service flow. However, the dynamic service flow technology is only used between the CM and CMTS and impacts the resource allocation to the CM by the CMTS; it does not target the specific client station connected with the CM. Moreover, there is no capability of providing the user with the configuration of special service flows targeting specific client stations.

### SUMMARY OF THE INVENTION

Some aspects of the present publication relate to a cable modem, i.e. CM, comprising a memory unit, in which instructions are saved, and a processor. The processor is configured to execute the instructions saved in said memory unit so that said electronic device executes the following operations: Receiving special service flow configuration information; said special service flow configuration information comprises information, which is configured by users and used for enabling the establishment of special service flows with one or a plurality of client stations connected with the CM; and establishing said special service flows with the cable modem terminal system, i.e. the CMTS, using the dynamic service flow technology based on said special service flow configuration information; said special service flows are only used for the communication with said one or plurality of client stations.

In some embodiments, said special service flow configuration information comprises the following information: said MAC address(es) of one or a plurality of client stations, bandwidth supported by said special service flow, and priority.

In some embodiments, said processor is also configured to execute the instructions saved in said memory unit so that said CM executes the following operations to establish said special service flows: based on said special service flow configuration information, transmitting to said CMTS the dynamic service addition - request, i.e. DSA-REQ and receiving from the CMTS the dynamic service addition - response, i.e. DSA-RSP, in response to the DSA-REQ.

In some embodiments, the information related to the MAC address(es) of said one or a plurality of client stations is included in the upstream service flow encoding field and downstream service flow encoding field in the DSA-REQ and DSA-RSP;

Information related to the bandwidth supported by said special service flows and said priority is included in the upstream service flow encoding field and downstream service flow encoding field in the DSA-REQ and DSA-RSP.

In some embodiments, said processor is also configured to execute the instructions saved in said memory unit so that said CM executes the following operations: acquiring the private network IPv4 address(es) of the MAC address(es) of said one or a plurality of client stations, mapping said private network IPv4 address(es) to the gateway IPv4 address(es) and corresponding port number(s), and using the mapped gateway IPv4 address(es) and corresponding port number(s) as the information related to the MAC address(es) of said one or plurality of client stations.

In some embodiments, said processor is also configured to execute the instructions saved in said memory unit so that said CM executes the following operations to use the dynamic service flow technology based on said special service flow configuration information and said CMTS to establish special service flows: Mapping said MAC address(es) to the IPv6 address(es) and using mapped IPv6 address(es) as the information related to the MAC address(es) of said one or plurality of client stations.

In some embodiments, said one or a plurality of client stations comprise at least one Wi-Fi client station connected with said CM via a Wi-Fi access point. Said processor is also configured to execute the instructions saved in said memory unit so that said CM executes the following operations: Transmitting at least a portion of said special service flow configuration information to said Wi-Fi access point so that, based on said at least a portion of said special service flow configuration information, the Wi-Fi access point configures the airtime percentage and priority for said Wi-Fi client stations to ensure the ability to realize the bandwidth supported by said special service flows.

In some embodiments, said special service flow configuration information also comprises the following information: Said special service flow accounts for the bandwidth of the original basic service flow or uses the newly added bandwidth.

In some embodiments, said processor is also configured to execute the instructions saved in said memory unit so that said CM executes the following operations: Determining that said special service flows instructed by said special service flow configuration information use the bandwidth of the original basic service flow, executing a re-initialize MAC operation, establishing a new basic service flow with said CMTS, and establishing said special service flow with said CMTS using the dynamic service flow technology based on said special service flow configuration information, wherein the total bandwidth of said new basic service flow and said special service flow is equal to the bandwidth of said original basic service flow.

In some embodiments, said processor is also configured to execute the instructions saved in said memory unit so that said CM executes the following operations: Determining that said special service flow uses the newly added bandwidth and establishing said special service flow with said CMTS using the dynamic service flow technology based on said special service flow configuration information.

In some embodiments, the CM integrates at least one of the following functions: said Wi-Fi AP, a gateway, and a router.

Some other aspects of the present publication relate to a method executed by the CM, comprising: Receiving special service flow configuration information; said special service flow configuration information comprises information, which is configured by users and used for enabling the establishment of special service flows with one or a plurality of client stations connected with the CM; and establishing said special service flows with the cable modem terminal system, i.e. the CMTS, using the dynamic service flow technology based on said special service flow configuration information; said special service flows are only used for the communication with said one or plurality of client stations.

In some embodiments, said special service flow configuration information comprises the following information: said MAC address(es) of one or a plurality of client stations, bandwidth supported by said special service flow, and priority.

In some embodiments, the operation of establishing said special service flows with the cable modem terminal system, i.e. the CMTS, using the dynamic service flow technology based on said special service flow configuration information further comprises: based on said special service flow configuration information, transmitting to said CMTS the dynamic service addition - request, i.e. DSA-REQ and receiving from the CMTS the dynamic service addition - response, i.e. DSA-RSP, in response to the DSA-REQ.

In some embodiments, the information related to the MAC address(es) of said one or a plurality of client stations is included in the upstream service flow encoding field and downstream service flow encoding field in the DSA-REQ and DSA-RSP. Information related to the bandwidth supported by said special service flows and said priority is included in the upstream service flow encoding field and downstream service flow encoding field in the DSA-REQ and DSA-RSP.

In some embodiments, the method also comprises: acquiring the private network IPv4 address(es) of the MAC address(es) of said one or a plurality of client stations, mapping said private network IPv4 address(es) to the gateway IPv4 address(es) and corresponding port number(s), and using the mapped gateway IPv4 address(es) and corresponding port number(s) as the information related to the MAC address(es) of said one or plurality of client stations.

In some embodiments, the method also comprises: Mapping said MAC address(es) to the IPv6 address(es) and using mapped IPv6 address(es) as the information related to the MAC address(es) of said one or plurality of client stations.

In some embodiments, said one or a plurality of client stations comprise at least one Wi-Fi client station connected with said CM via a Wi-Fi access point. Said method also comprises: Transmitting at least a portion of said special service flow configuration information to said Wi-Fi access point so that, based on said at least a portion of said special service flow configuration information, the Wi-Fi access point configures the airtime percentage and priority for said Wi-Fi client stations to ensure the ability to realize the bandwidth supported by said special service flows.

Some other aspects of the present publication relate to a non-transitory computer readable medium, in which instructions are saved; when said instructions are executed by the processor of a cable modem, i.e. CM, said CM executes the operations described in the method above.

Other aspects of the present publication relate to a device implemented by a cable modem, i.e. CM, comprising components for executing the operations described in the method above.

### DESCRIPTION OF ATTACHED FIGURES

To better understand the present publication and illustrate how to realize the present publication, examples are described by referencing attached figures, wherein:

FIG. 1 is a schematic of an example of the network system according to an embodiment of the present publication.

FIG. 2 is a configuration block diagram of an example of an electronic device according to an embodiment of the present publication.

FIG. 3 is a process flow chart of an example of a method executed by a CM according to an embodiment of the present publication.

FIG. 4 is a process flow chart of an example of a method executed by a CM according to some other embodiments of the present publication.

FIG. 5 is a process flow chart of an example of a method executed by a CM according to some other embodiments of the present publication.

Please note that in all attached figures, similar labels refer to corresponding sections. Moreover, a plurality of examples of the same section are designated by a common prefix separated by a dash and the example number.

### SPECIFIC EMBODIMENTS

[Specific embodiments] are described in detail below by referencing the attached figures, and the detailed descriptions below is provided to help comprehensively understand various examples of the embodiments of the publications. The description below comprises details to help understand. However, such details should merely be considered as examples, but not limitation to the present publication. The present publication is limited by the claims and their equivalent content. The words and phrases used in the description below are only used for the ability to clearly and consistently understand the present publication. Moreover, for the sake of clarity and concision, the description of known structures, functions, and configurations may be omitted. Those of ordinary skill in the art will realize that various alterations and revisions may be made to the examples described in this article, provided that they do not deviate from the spirit and scope of the present publication.

As mentioned above, a user can only affect the resource allocation to a specific MAC address at the Wi-Fi AP side by configuring the ATM; however, the service flow established by the dynamic service flow technology between the CM and CMTS can only guarantee the resource allocation to the CM by the CMTS, and does not target the specific client station connected with the CM. Moreover, there is no capability of providing the user with the configuration of special service flows targeting specific client stations.

At least one of the purposes of the present publication is to establish special service flows targeting specific client stations using the dynamic service flow technology based on the user configuration.

Furthermore, the present publication also combines the ATM capability of the Wi-Fi AP so that targeting Wi-Fi Stations connected from the Wi-Fi AP to the CM, guaranteed channels from the CMTS to Wi-Fi Stations can be established.

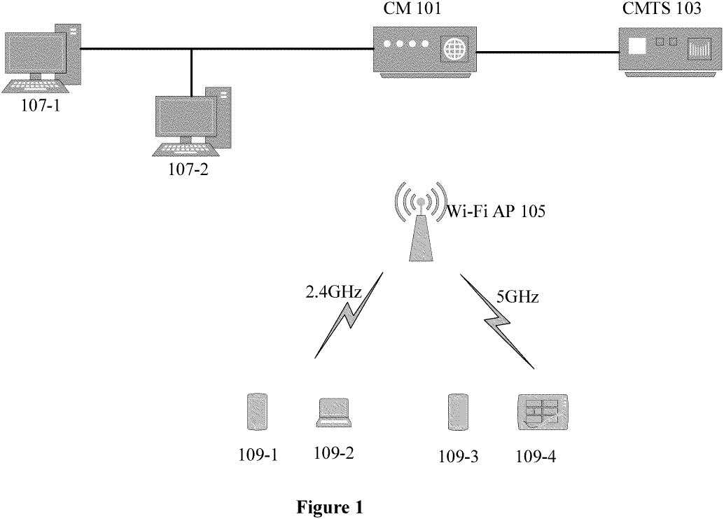

FIG. 1 is a schematic of an example of the network system according to an embodiment of the present publication. As shown in FIG. 1, the network system comprises a CM 101, which is connected to a CMTS 103 via a hybrid fiber coaxial (HFC) cable. LAN Stations 107-1 and 107-2 are connected to the CM 101; Wi-Fi Stations 109-1 to 109-4 are connected to the CM 101 via, for example, the Wi-Fi AP 105.

A client station may include, but not be limited to: a desktop computer, laptop computer, notebook/netbook, computer, tablet, smart phone, cell phone, smart watch, wearable device, consumer electronic device, portable computing device, test device, and/or other electronic device.

The Wi-Fi AP 105 shown in FIG. 1 is an independent device separated from the CM 101, and may be connected to the CM 101 via, for example, a wired link or wireless link. However, those of ordinary skill in the art may understand that the Wi-Fi AP 105 may be integrated in the CM 101. The Wi-Fi AP 105 may comprise one or a plurality of radios operating at different frequency bands. For example, as shown in FIG. 1, the Wi-Fi AP 105 may include two radios (not shown) operating at 2.4 GHz and 5 GHz respectively, wherein the Wi-Fi Stations 109-1 and 109-2 may be connected to the Wi-Fi AP 105 via a wireless link operating at 2.4 GHz while the Wi-Fi Stations 109-3 and 109-4 may be connected to the Wi-Fi AP 105 via a wireless link operating at 5 GHz.

Those of ordinary skill in the art may understand that although FIG. 1 only shows two LAN Stations and four Wi-Fi Stations, the number of LAN Stations and Wi-Fi Stations may be configured according to actual circumstances.

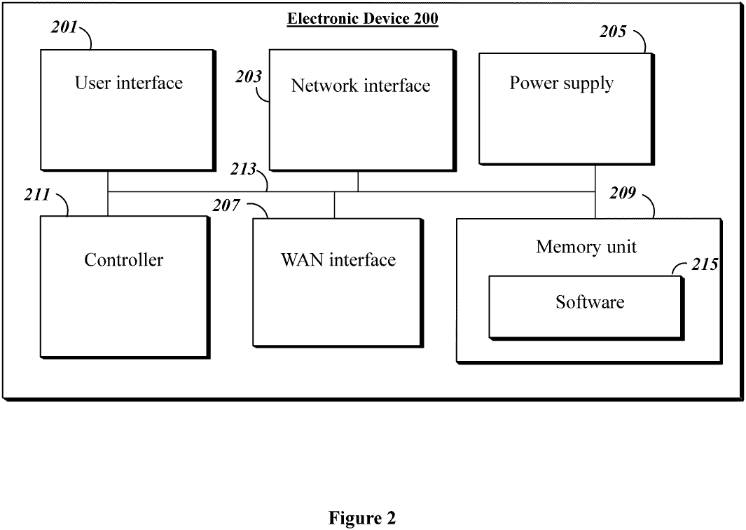

FIG. 2 is a configuration block diagram of an example of an electronic device 200 according to an embodiment of the present publication.

The electronic device 200, for example, corresponds to the CM 101 in FIG. 1.

The electronic device 200 may be an electronic device combining one or a plurality of functions of a modem, access point, gateway, and/or router. The present publication also envisions that the electronic device 200 may comprise, but not be limited to, functions of an IP/QAM set top box (STB) or a smart media device (SMD); the IP/QAM set top box or smart media device can decode audio/video contents and play contents provided by OTT (Over The Top) or a multiple system operator (MSO).

As shown in FIG. 2, the electronic device 200 comprises a user interface 201, a network interface 203, a power supply 205, a WAN interface 207, a memory unit 209, and a controller 211. The user interface 201 may comprise, but not be limited to, a button, keyboard, small keyboard, LCD, CRT, TFT, LED, HD, or other similar display devices, including display devices with the touch screen capability enabling the interaction between the user and the gateway device. The network interface 21 may comprise various types of network cards and circuit systems realized by software and/or hardware so that a wireless agreement can be used for the communication between a wireless extender device and a client device; a wireless agreement may be any IEEE 802.11 Wi-Fi agreement, Bluetooth agreement, Bluetooth low energy (BLE) or other short-distance agreement operating according to the wireless technological standards, for exchanging data in a short distance using any approved or unapproved frequency band (for example, citizens broadband radio service (CBRS) frequency band, 2.4 GHz frequency band, 5 GHz frequency band, or 6 GHz frequency band), RF4CE agreement, ZigBee agreement, Z-Wave agreement, or IEEE 802.15.4 agreement.

The power supply 205 provides power to internal components of the electronic device 200 via the internal controller 213. The power supply 205 may be self-powered, for example, a battery pack; its interface is charged by a charger connected (for example, directly or via another device) to an outlet. The power supply 205 may also comprise a rechargeable battery, which is removable for replacement, for example, a NiCd, NiMH, Li-ion, or Li-pol battery. The WAN interface 207 may comprise various types of network cards and circuit systems realized by software and/or hardware, to realize the communication of the router device with the Internet service provider or multi-system operator.

The memory unit 209 comprises a single memory unit or one or a plurality of memory units or memory locations, including but not limited to the random access memory (RAM), dynamic random access memory (DRAM), static random access memory (SRAM), read only memory (ROM), EPROM, EEPROM, flash memory, FPGA logic block, hard drive, or any other layers of a memory hierarchy. The memory unit 209 may be used to save any type of instructions, software, or algorithms, and it comprises a software 215 for controlling general functions and operations of the electronic device 200.

The controller 211 controls the general operations of the electronic device 200 and executes the administrative functions related to other devices in the network (for example, extenders and client devices). The controller 211 may comprise, but not be limited to, a CPU, hardware microprocessor, hardware processor, multi-core processor, single-core processor, microcontroller, application specific integrated circuit (ASIC), DSP, or other similar processing device, and is able to execute any type of instructions, algorithms, or software for controlling the operations and functions of the electronic device 200 according to the embodiments described in the present publication. The controller 211 may be various types of realizations of digital circuit systems, analog circuit systems, or mixed signal (a combination of analog and digital signals) circuit systems executing functions in the computer system. The controller 211 may comprise an integrated circuit (IC), a portion or circuit of a separate processor core, an entire processor core, a separate processor, a programmable hardware device, such as a field programmable gate array (FPGA), and/or a system comprising a plurality of processors.

The communication among components of the electronic device 200 (for example, 201-205, 209, and 211) can be established by the internal bus 213.

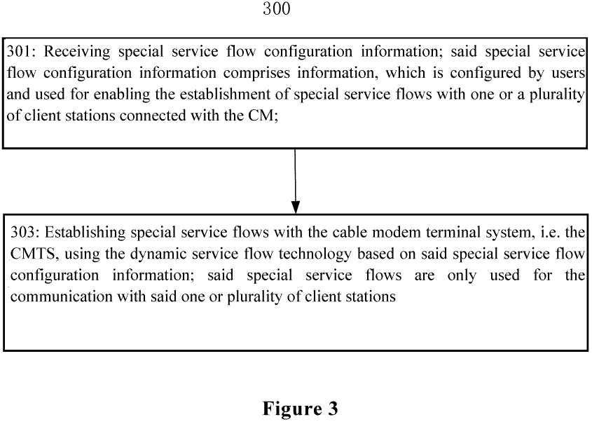

FIG. 3 is a process flow chart of an example of a method 300 executed by a CM according to an embodiment of the present publication. The method 300, for example, may be executed by the CM 101 in FIG. 1.

### Receiving Special Service Flow Configuration Information

As shown in FIG. 3, the method 300 comprises a step 301. In this step, the CM receives special service flow configuration information; the special service flow configuration information comprises information, which is configured by users and used for enabling the establishment of special service flows with one or a plurality of client stations connected with the CM.

A user may configure the special service flows by visiting related configuration pages via applications installed on computers and applets, i.e. APP, installed on smart phones or tablets.

In some embodiments, for example, a user may configure the special service flows by selecting using the originally purchased bandwidth (for example, 100 M) or selecting the newly added bandwidth or using additionally purchased bandwidth (for example, 30 M) via the configuration page. If the user selects using the originally purchased bandwidth, it means that the originally purchased bandwidth (for example, 100 M) is divided into the bandwidth for basic service flows (for example, 70 M) or the bandwidth for special service flows (for example, 30 M). If the user selects using the newly added bandwidth or additionally purchased bandwidth, the user may retain the original bandwidth for basic service flows and only use the newly purchased bandwidth for special service flows.

In some embodiments, the user may also configure the number of special service flows to be established via the configuration page, for example, establishing one special service flow or a plurality of special service flows. The user may also configure the bandwidth of every special service flow.

In some embodiments, the user may also configure the address information, such as, the MAC address, of the specific client station targeted by every special service flow via the configuration page. A special service flow may configure one MAC address, i.e. the bandwidth of the special service flow is used for a single client station (in FIG. 1, for example, any one of the client stations 107-1, 107-2, 109-1 to 109-4). A special service flow may configure a plurality of MAC addresses, i.e. the bandwidth of the special service flow is used for a plurality of client stations corresponding to the plurality of MAC addresses (in FIG. 1, for example, a plurality of client stations of 107-1, 107-2, 109-1 to 109-4).

Moreover, the user may also designate the priority via the configuration page, for example, designating the priority of the special service flow as “high.” This means that when the CMTS allocates resources, the bandwidth of the special service flow is guaranteed by the high priority.

In some embodiments, the special service flow configuration formed based on the aforementioned user configuration for every special service flow may comprise one or a plurality of the following: Whether the special service flow uses the bandwidth of the original basic service flow or uses the newly added bandwidth, the MAC address(es) of one or a plurality of client stations targeted by the special service flow, the bandwidth supported by the special service flow, and priority.

The special service flow configuration information may be, for example, transmitted to the CM via a server (for example, a business server and its saved information related to the services purchased by the user). In some embodiments, the special service flow configuration may cause changes to the server targeting the remote configuration file of the CM; afterward, the changed remote configuration file containing the special service flow configuration information is transmitted to the CM.

In the present publication, a special service flow established between the CM and CMTS may comprise a pair of upload service subflow and download service subflow, wherein the bandwidth supported by the special service flow usually refers to the bandwidth supported by the download service subflow. For example, if the bandwidth supported by the special service flow configured by the user is 30 M, it means that the bandwidth supported by the download service subflow of the special service flow is 30 M.

### Establishing Special Service Flow

As shown in FIG. 3, the method 300 also comprises a step 303; in this step, the CM establishes special service flows with the cable modem terminal system, i.e. the CMTS, using the dynamic service flow technology based on said special service flow configuration information; said special service flows are only used for the communication with said one or plurality of client stations (i.e. client stations configured by the user targeting the special service flow).

For example, after the CM receives the remote configuration file (more specifically, the special service flow configuration information), said special service flow may be established between the CM and CMTS using the dynamic service flow technology based on said special service flow configuration information.

The special service flow established using the dynamic service flow technology is different from the basic service flow established between the CM and CMTS. The basic service flow is used for all client stations of the CM, i.e. all client stations of the CM compete with each other for the bandwidth provided by the basic service flow. Moreover, hundreds of CMs are usually connected in the CMTS; when the network is congested, CMs compete with each other; the basic service flow of the CM will be impacted, which further impact the bandwidth supply by the CM to the client stations.

However, the special service flow established by the dynamic service flow technology is only used for client stations configured by the user targeting the special service flow, and it has the high priority. This means regardless of the competition among CMs of the CMTS and regardless of the competition among client stations of the CM, the special service flows established at the CM/CMTS targeting the configured client stations may guarantee the high priority of allocating the configured bandwidth to those configured client stations, and thus are not impacted by the network congestion.

Thus, the embodiments of the present publication may enable users to configure special service flows targeting specific client stations of the family network to provide good bandwidth guarantee to client stations of real-time services and improve user experience.

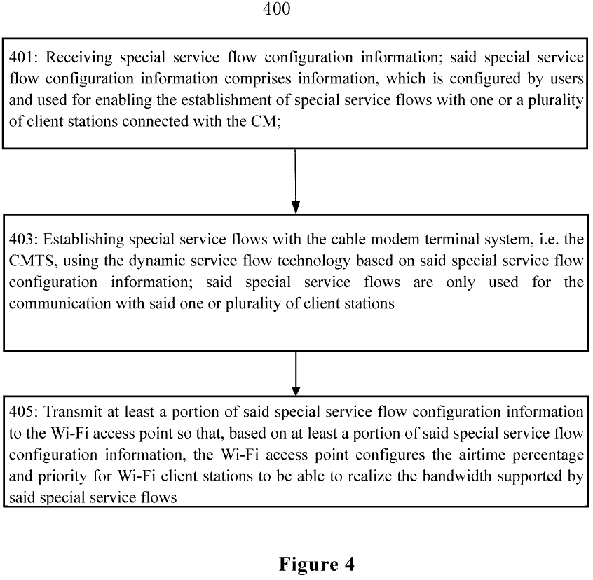

FIG. 4 is a process flow chart of an example of a method 400 executed by a CM according to some other embodiments of the present publication.

As shown in FIG. 1, one or a plurality of client stations configured by the user targeting special service flows may comprise at least one Wi-Fi client station (for example, Wi-Fi stations 109-1 to 109-4) connected to the CM (for example, the CM 101 in FIG. 1) via the Wi-Fi access point (for example, the Wi-Fi AP 105 in FIG. 1). Under such circumstance, when the special service flows are established at the CM and CMTS targeting the configured Wi-Fi client stations, as the Wi-Fi client stations are connected to the CM via the Wi-Fi access point, the bandwidth supply at the Wi-Fi client stations is also impacted by the resource allocation at the Wi-Fi access point. For example, assuming that a plurality of Wi-Fi client stations connected to the Wi-Fi access point compete with each other for the capabilities (for example, the throughput or airtime) provided by the Wi-Fi access point, if other Wi-Fi client stations use excessive airtime, even if special service flows of a certain bandwidth (for example, 30 M) are established at the CM and CMTS targeting configured Wi-Fi client stations, the 30 M bandwidth may not be actually realized as the Wi-Fi access point may not allocate enough airtime to the Wi-Fi client stations.

Under certain circumstances, the Wi-Fi access point may comprise a plurality of radios using different operating frequency bands (for example, 2.4 GHz frequency band and 5 GHz frequency band shown in FIG. 1); the Wi-Fi client stations on the 2.4 GHz frequency band (for example, 109-1 and 109-2 in FIG. 1) and the Wi-Fi client stations on the 5 GHz frequency band (for example, 109-3 and 109-4 in FIG. 1) may also compete for the capabilities provided by the Wi-Fi access point. For example, if a Wi-Fi client station on the 2.4 GHz frequency band uses excessive airtime, even though the special service flow of a certain bandwidth (for example, 30 M) is established at the CM and CMTS targeting the Wi-Fi client stations on the 5 GHz frequency band, the guarantee of such bandwidth for the Wi-Fi client stations on the 5 GHz frequency band still cannot be realized.

The method in FIG. 4 further considers the scenario above and provides a realization combining the dynamic service flow technology and ATM technology.

The steps 401 and 403 in FIG. 4 are the same as the steps 301 and 303 in FIG. 3. The detailed description is herein omitted.

### Realization at the Wi-Fi AP Side

The method 400 in FIG. 4 further comprises the step 405; in this step, the CM transmits at least a portion of said special service flow configuration information to the Wi-Fi access point so that, based on said at least a portion of said special service flow configuration information, the Wi-Fi access point configures the airtime percentage and priority for the Wi-Fi client stations to be able to realize the bandwidth supported by said special service flows.

In some embodiments, the CM may transmit the following information in the special service flow configuration information to the Wi-Fi access point: MAC address of the configured Wi-Fi Station, bandwidth supported by the special service flow related to the MAC address, and priority related to the MAC address.

Assuming that the bandwidth supported by the special service flow related to the MAC address of the configured Wi-Fi Station is 30 M and the priority is high while the total capability of the Wi-Fi access point is 300 M, at least 10% of the 300 M is allocated to the MAC address of the Wi-Fi Station and the high priority is allocated so that regardless of the competition among Wi-Fi Stations of the Wi-Fi access point, the guarantee of the 30 M bandwidth of the Wi-Fi Station can always be realized with the high priority. When the bandwidth (for example, 30 M) of the special service flow is not only used for the MAC address of the Wi-Fi Station (i.e. the special service flow is configured targeting a plurality of client stations), at least 10% of the 300 M may also be allocated to the MAC address of the Wi-Fi Station and the high priority is also allocated to guarantee the realization of the bandwidth at this Wi-Fi station.

Thus, targeting Wi-Fi Stations, some embodiments of the present publication further consider the resource allocation at the Wi-Fi access point and provide good bandwidth guarantee to Wi-Fi Stations of real-time services by combining the ATM technology to improve user experience.

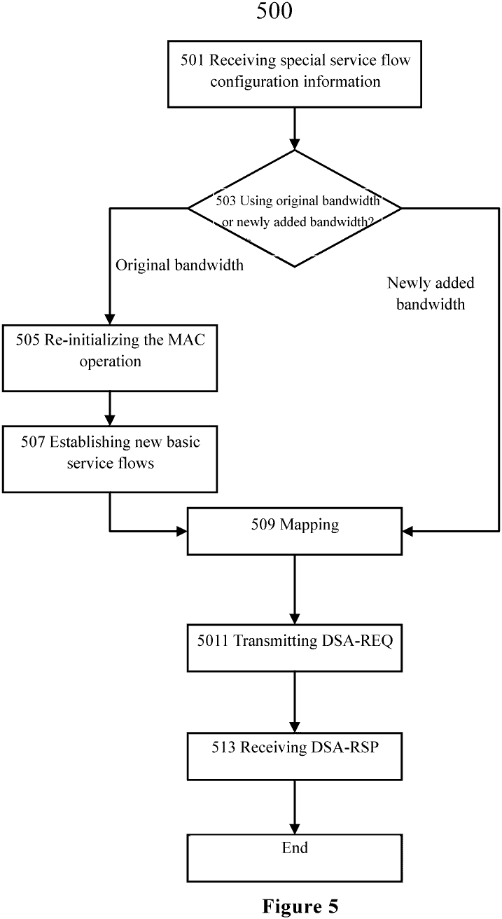

FIG. 5 is a process flow chart of an example of a method 500 executed by a CM according to some other embodiments of the present publication.

As shown in FIG. 5, the method 500 starts at the step 501; in this step, the CM receives the special service flow configuration information. This step is similar to the step 301 in FIG. 3 and step 401 in FIG. 4.

Table 1 shows an example 1 of the special service flow configuration information. In the example, the user configures a special service flow targeting a client station, and the special service flow uses 30% of the bandwidth of the original basic business flow.

TABLE 1

| | |
|---|---|
| Category of the bandwidth used by the special service flow | Bandwidth of the original basic business flow (100 M) |
| Percentage of the bandwidth supported by the special service flow | 30% (i.e. 30 M) |
| MAC address of the designated client station | 72:54:25:58:3d:ed |
| Priority information of the special service flow | High |

Table 2 shows an example 2 of the special service flow configuration information. In the example, the user configures a special service flow targeting a client station, and the special service flow uses 30% of the bandwidth of the original basic business flow.

TABLE 2

| | |
|---|---|
| Category of the bandwidth used by the special service flow | Newly added bandwidth |
| Percentage of the bandwidth supported by the special service flow | 30 M |
| MAC address of the designated client station | 72:54:25:58:3d:ed |
| Priority information of the special service flow | High |

As shown in FIG. 5, the method 500 comprises the step 503; in this step, based on the special service flow configuration information, the CM determines whether the special service flow uses the bandwidth of the original basic service flow or uses newly added bandwidth.

If the CM determines that the special service flow uses the bandwidth of the original basic service flow (the circumstance shown in Table 1), the method 500 proceeds to the step 505; in this step, the CM executes a re-initialize MAC operation. Optionally, the CM may also be re-started. In some embodiments, the user configuration causes changes to the remote configuration file in the server; when receiving the changed remote configuration file, the CM determines that the new basic business flow with the bandwidth (for example, 70 M) has to be re-established.

Afterward, the method 500 proceeds to the step 507; in this step, based on the special service flow configuration information, a new basic business flow is established. Afterward, the method 500 proceeds to the step 509.

When it is determined that the special service flow uses the newly added bandwidth in the step 503 (the circumstance shown in Table 2), i.e. the user maintains the bandwidth of the original basic service flow and purchases newly added bandwidth, the method 500 proceeds to the step 509.

In the step 509, the CM executes the mapping of the MAC address.

Table 3 shows the mapping of the examples of the MAC address shown in Table 1 or Table 2.

TABLE 3

| MAC address of the designated client station | Private network IP address | Mapped public network IP address | Mapped port | Address information sent to the CMTS |
|---|---|---|---|---|
| 72:54:25:58:3d:ed | 192.168.0.116 | 10.91.68.116 | 60000 | 10.91.68.116 (60000) |

As shown in Table 3, for example, the CM acquires the private network IP address “192.168.0.116” corresponding to the MAC address from a gateway or using its internally integrated gateway function and then maps the private network IP address to the public IP address “10.91.68.116” provided by the MSO as well as the corresponding port “60000.” Afterward, the CM transmits the information of the mapped IP address and port rather than the MAC address of the client station to the CMTS.

Table 4 shows the mapping of an example of a plurality of MAC addresses configured targeting one special service flow.

TABLE 4

| MAC address of the designated client station | Private network IP address | Mapped public network IP address | Mapped port | Address information sent to the CMTS |
|---|---|---|---|---|
| 72:54:25:58:3d:ed | 192.168.0.116 | 10.91.68.116 | 60000 | 10.91.68.116 (60000-60002) |
| 72:54:25:58:3d:ee | 192.168.0.117 | 10.91.68.116 | 60001 | |
| 72:54:25:58:3d:ef | 192.168.0.118 | 10.91.68.116 | 60002 | |

As shown in FIG. 4, when a plurality of MAC addresses are configured targeting a special service flow, the private IP address corresponding to every MAC address is acquired and mapped to the public network IP address “10.91.68.116” and one of the respective corresponding port from “60000” to “60002.” Afterward, the CM transmits the mapped IP address and the port information, i.e. “10.91.68.116(60000-60002)” rather than the MAC address of the client station to the CMTS.

As shown in FIG. 3 and FIG. 4, the mapped public network IP address is the public network address of the gateway related to the CM.

Table 3 and Table 4 above are mapping examples based on IPv4. Table 5 shows mapping examples based on IPv6 when a plurality of MAC addresses are configured targeting a special service flow.

TABLE 5

| MAC address of the designated client station | mapped IPv6 address | Address information sent to the CMTS |
|---|---|---|
| 72:54:25:58:3d:ed | 2001:1234:6065::142:1 | 2001:1234:6065::142:1/112 |
| 72:54:25:58:3d:ee | 2001:1234:6065::142:2 | |
| 72:54:25:58:3d:ef | 2001:1234:6065::142:3 | |

As shown in Table 5, the mapping based on IPv6 directly maps MAC addresses to the IPv6 addresses. Afterward, the CM provides the IP segment “2001:1234:6065::142:1/112” corresponding to these IPv6 addresses to CMTS.

Next, reference FIG. 5; the method proceeds to the step 511; the CM transmits the dynamic service addition - request (DSA-REQ) to the CMTS based on the special service flow configuration information.

Afterward, in step 513, the CM receives the dynamic service addition — response (DSA-RSP) in response to the DSA_REQ from the CMTS.

The DSA-REQ and DSA-REQ both comprise the upstream packet classification encoding field, downstream packet classification encoding field, upstream service flow encoding field, and downstream service flow encoding field. The upstream packet classification encoding field defines parameters related to the upstream packet classification. The downstream packet classification encoding field defines parameters related to the downstream packet classification. The upstream service flow encoding field [defines] parameters related to the upstream scheduling for the service flow. The downstream service flow encoding field defines parameters related to the downstream scheduling for the service flow.

In some embodiments, when the CM transmits the DSA_REQ to CMTS based on the special service flow configuration information, it includes the information related to the configured MAC address(es) of one or a plurality of client stations (for example, as shown in the “address information transmitted to the CMTS” in Table 3-5) in the upstream packet classification encoding field and downstream packet classification encoding field of DSA-REQ and includes the information related to the bandwidth supported by the special service flow and the priority in the upstream packet classification encoding field and downstream packet classification encoding field of DSA-REQ.

The information related to configured MAC address(es) of one or a plurality of client stations is also included in the upstream packet classification encoding field and downstream packet classification encoding field of DSA-RSP from the CMTS, and the information related to the bandwidth supported by the special service flow and the priority is also included in the upstream service flow classification encoding field and downstream service flow classification encoding field.

Thus, special service flows are established between the CM and CMTS targeting specific MAC addresses.

Tables 1-5 only show the circumstances of configuring one or a plurality of client stations targeting a single service flow. Those of ordinary skill in the art may understand that, provided that a plurality of service flows are configured by the user, the service flow identification information may be added. FIG. 5 only shows the operations, which are executed by the CM and are related to the use of the dynamic service flow technology between the CM and CMTS. However, those of ordinary skill in the art may understand that, provided that the configured client stations include Wi-Fi Stations, the ATM technology at the Wi-Fi AP may be used as described above to realize the support of the bandwidth of the special service flow at the Wi-Fi side (for example, as shown in the step 405 in FIG. 4).

The present publication also be realized as any combination computer programs on devices, systems, integrated circuits, and non-transitory computer readable media. One or a plurality of processors may be realized as an integrated circuit (IC), application specific integrated circuit (ASIC) or large-scale integration (LSI), system LSI, very LSI, or components of very LSI executing some of all functions described in the present publication.

According to various steps of the method of the present publication, a plurality of components included in the device may also be used for execution respectively. According to an embodiment, these components can be implemented as computer program modules established to realize various steps of the method; however, a device including these components may realize the program module structure of the method by computer programs.

The present publication comprises the use of software, applications, computer programs or algorithms. The software, applications, computer programs, or algorithms may be saved on non-transitory computer readable media so that, for example, a computer with one or a plurality of processors may execute the aforementioned steps and the steps described in the Attached Figures. For example, one or a plurality of memory units save software or algorithms via executable instructions, and one or a plurality of processors may relate to a set of instructions executing the software or algorithms to enhance security in any number of wireless networks according to the embodiments described in the present publication.

Software and computer programs (also may be referred to as programs, software applications, applications, modules or codes) comprise machine instructions used for programmable processors and may be realized by high-level procedural languages, object-oriented programming languages, functional programming languages, logic programming languages, assembly languages, and machine languages. The term “computer readable medium” refers to any computer programming product, device, or apparatus for providing machine instructions or data to programmable data processors, for example, disks, compact disks, solid state storage devices, memories, and programmable logic devices (PLD), including computer readable media receiving machine instructions as computer readable signals.

For example, computer readable media may comprise a dynamic random-access memory (DRAM), random-access memory (RAM), read-only memory (ROM), electrically erasable programmable read-only memory (EEPROM), compact disk read-only memory (CD_ROM) or other compact disk storage device, disk storage device or other magnetic storage device, or any other medium, which may be used to carry or save required computer readable program codes in the format of instructions or data structures and can be accessed by general or special computers or general or special processors. As used in the present article, magnetic disks or disks comprise compact disks (CD), laser disks, compact disks, digital versatile disks (DVD), floppy disks, and Blu-ray disks, wherein magnetic disks usually copy data magnetically while disks copy data optically via laser. The aforementioned combinations are also included in the scope of computer readable media.

In one or a plurality of embodiments, the use of the words, “can,” “able to,” “may be operated as” or “configured as” refers to some devices, logic, hardware and/or components designed to be used in a designated manner. The motive of the present publication is to provide examples of devices, systems, methods, and programs for executing the features described in the present publication. However, besides the features above, other features or modifications may also be expected. It can be expected that any newly emerged technology potentially replacing any technology of the realization above may be used to complete the realization of components and functions of the present publication.

Moreover, the description above provides examples, but does not limit the scope, applicability, or configuration described in the claims. Without deviating from the spirit and scope of the present publication, the functions and layouts of discussed components may be changed. Various embodiments may appropriately omit, replace, or add various processes or components. For example, features described in certain embodiments may be combined in other embodiments.

Similarly, although operations are described in a specific sequence in Attached Figures, however, it should not be understood that the operations are required to be executed in the specific sequence or order as shown or that the execution of all operations shown in the Figures is required to realize the desired result. Under certain circumstances, multitasking and parallel processing may be beneficial.

1. A cable modem, i.e. CM, comprising:
a memory unit, in which instructions are saved; and
a processor, configured to execute the instructions saved in said memory unit so that said electronic device executes the following operations:
receiving special service flow configuration information; said special service flow configuration information comprises information, which is configured by users and used for enabling the establishment of special service flows with one or a plurality of client stations connected with the CM; and
establishing said special service flows with the cable modem terminal system, i.e. the CMTS, using the dynamic service flow technology based on said special service flow configuration information; said special service flows are only used for the communication with said one or plurality of client stations.

2. A CM as described in claim 1, wherein said special service flow configuration information comprises the following information:
MAC address(es) of said one or a plurality of client stations;
bandwidth supported by said special service flows; and priority.

3. A CM as described in claim 2, wherein said processor is also configured to execute instructions saved in said memory unit so that said CM executes the following operations to establish said special service flow:
based on said special service flow configuration information, transmitting to said CMTS the dynamic service addition-request, i.e. DSA-REQ; and
receiving from the CMTS the dynamic service addition-response, i.e. DSA-RSP, in response to the DSA-REQ.

4. A CM as described in claim 3, wherein
the information related to the MAC address(es) of said one or a plurality of client stations is included in the upstream service flow encoding field and downstream service flow encoding field in the DSA-REQ and DSA-RSP;
information related to the bandwidth supported by said special service flows and said priority is included in the upstream service flow encoding field and downstream service flow encoding field in the DSA-REQ and DSA-RSP.

5. A CM as described in claim 4, wherein said processor is also configured to execute instructions saved in said memory unit so that said CM executes the following operations:
acquiring the private network IPv4 address(es) of the MAC address(es) of said one or a plurality of client stations;
mapping said private network IPv4 address(es) to the gateway IPv4 address(es) and corresponding port number(s); and
using the mapped gateway IPv4 address(es) and corresponding port number(s) as the information related to the MAC address(es) of said one or a plurality of client stations.

6. A CM as described in claim 4, wherein said processor is also configured to execute instructions saved in said memory unit so that said CM executes the following operations to establish special service flows with said CMTS using the dynamic service flow technology based on said special service flow configuration information:
mapping said MAC address(es) to the IPv6 address(es); and
using IP segments corresponding to the mapped IPv6 address(es) as the information related to the MAC address(es) of said one or a plurality of client stations.

7. A CM as described in claim 2, wherein said one or a plurality of client stations comprise at least one Wi-Fi client station connected to said CM via a Wi-Fi access point (AP),
Said processor is also configured to execute the instructions saved in said memory unit so that said CM executes the following operations:
transmitting at least a portion of said special service flow configuration information to said Wi-Fi access point so that, based on said at least a portion of said special service flow configuration information, said Wi-Fi access point configures the airtime percentage and priority for said Wi-Fi client stations to ensure the ability to realize the bandwidth supported by said special service flows.

8. A CM as described in claim 2, wherein said special service flow configuration information also comprises the following information:
Said special service flow accounts for the bandwidth of the original basic service flow or uses the newly added bandwidth.

9. A CM as described in claim 8, wherein said processor is also configured to execute the instructions saved in said memory unit so that said CM executes the following operations:
determining that said special service flows instructed by said special service flow configuration information use the bandwidth of the original basic service flow;
executing a re-initialize MAC operation;
establishing a new basic service flow with said CMTS; and
establishing said special service flow with said CMTS using the dynamic service flow technology based on said special service flow configuration information;
wherein the total bandwidth of said new basic service flow and said special service flow is equal to the bandwidth of said original basic service flow.

10. A CM as described in claim 8, [wherein] said processor is also configured to execute the instructions saved in said memory unit so that said CM executes the following operations:
determining that said special service flows use the newly added bandwidth; and
establishing said special service flow with said CMTS using the dynamic service flow technology based on said special service flow configuration information.

11. (canceled)

12. A method executed by a cable modem, i.e. CM, comprising:
receiving special service flow configuration information; said special service flow configuration information comprises information, which is configured by users and used for enabling the establishment of special service flows with one or a plurality of client stations connected with the CM; and
establishing said special service flows with the cable modem terminal system, i.e. the CMTS, using the dynamic service flow technology based on said special service flow configuration information; said special service flows are only used for the communication with said one or plurality of client stations.

13. A method as described in claim 12, wherein said special service flow configuration information comprises the following information:
MAC address(es) of said one or a plurality of client stations;
bandwidth supported by said special service flows; and priority.

14. A method as described in claim 13, wherein the operation of establishing said special service flows with the cable modem terminal system, i.e. the CMTS using the dynamic service flow technology based on said special service flow configuration information further comprises:
based on said special service flow configuration information, transmitting to said CMTS the dynamic service addition-request, i.e. DSA-REQ; and
receiving from the CMTS the dynamic service addition-response, i.e. DSA-RSP, in response to the DSA-REQ.

15. A method as described in claim 14, wherein
the information related to the MAC address(es) of said one or a plurality of client stations is included in the upstream service flow encoding field and downstream service flow encoding field in the DSA-REQ and DSA-RSP;
information related to the bandwidth supported by said special service flows and said priority is included in the upstream service flow encoding field and downstream service flow encoding field in the DSA-REQ and DSA-RSP.

16. A method as described in claim 15, further comprising:
acquiring the private network IPv4 address(es) of the MAC address(es) of said one or a plurality of client stations;
mapping said private network IPv4 address(es) to the gateway IPv4 address(es) and corresponding port number(s); and
using the mapped gateway IPv4 address(es) and corresponding port number(s) as the information related to the MAC address(es) of said one or a plurality of client stations.

17. A method as described in claim 15, further comprising:
mapping said MAC address(es) to the IPv6 address(es); and
using IP segments corresponding to the mapped IPv6 address(es) as the information related to the MAC address(es) of said one or a plurality of client stations.

18. A method as described in claim 13, wherein said one or a plurality of client stations comprise at least one Wi-Fi client station connected with said CM via a Wi-Fi access point (AP),
Said method also comprises:
transmitting at least a portion of said special service flow configuration information to said Wi-Fi access point so that, based on said at least a portion of said special service flow configuration information, said Wi-Fi access point configures the airtime percentage and priority for said Wi-Fi client stations to ensure the ability to realize the bandwidth supported by said special service flows.

19. (canceled)

20. (canceled)
